(19) United States
(12) Patent Application Publication
(10) Pub. No.: US 2006/0192452 A1
(43) Pub. Date: Aug. 31, 2006

(54) Spindle motor

(76) Inventors: Yasunori Tokuno, Saijyou shi (JP); Yoshitada Higuchi, Oozu shi (JP)

Correspondence Address: WENDEROTH, LIND & PONACK L.L.P., 2033 K. STREET, NW, SUITE 800, WASHINGTON, DC, 20006, US

(21) Appl. No.: 11/176,265

(22) Filed: Jul. 8, 2005

(30) Foreign Application Priority Data
Jul. 9, 2004 (JP) 2004-203943

(51) Int. Cl. H02K 5/16; F16C 32/06

(52) U.S. Cl. 310/90; 384/107

(57) ABSTRACT

Object: A spindle motor of the type in which both ends of a shaft are fixed has a structure in which both ends of a hydrodynamic bearing are open to the atmosphere, and when the rotational precision of rotating bodies is poor, the bearing is subjected to a great deal of fluctuating stress, and leakage of the lubricant occurs.

Means for Solution: In a spindle motor having a fluid bearing in which a narrow gap is formed between the surface of a fixed shaft member and a sleeve component (rotating member), and this gap is filled with a lubricating fluid, the shaft member has an annular collar formed so as to protrude substantially perpendicularly to the cylindrical surface of the shaft member. The rotating member is such that the sleeve component fitted over the shaft member is constituted integrally with a hub component that fixes a magnetic disk, and an annular seal member is fixed to the upper end side of the shaft member.

### TECHNICAL FIELD

The present invention relates to a spindle motor that has a hydrodynamic bearing and is used in a magnetic disk device.

### BACKGROUND ART

Spindle motors featuring a hydrodynamic bearing are often used for the disk rotary drive motors of magnetic disk devices that record to and reproduce from magnetic disks, in order to reduce noise and increase speed.

With such magnetic disk devices, recording density must be raised in order to increase the recording capacity per magnetic disk and to raise the operating speed. To raise recording density, the rotational precision of the spindle motor that rotates the magnetic disk must be increased and the rotation must be stable, so a type of motor that is fixed at both shaft ends, which affords greater rotational stability, is suited to this task. With a motor that is fixed at both shaft ends, the ends of the shaft are fixed to a frame or the like, and a sleeve into which the shaft is inserted rotates. A rotating magnetic disk or the like is attached to this sleeve.

Magnetic disk devices have come to be used in various kinds of mobile devices in recent years. Mobile devices may be subjected to external forces during their use, and it is preferable for the housing not to be deformed by these forces to the extent that the internal magnetic disk or magnetic head is damaged, as this affords greater reliability. One possible way to accomplish this is to support the housing of the device with a shaft such that both ends of the above-mentioned spindle motor shaft are fixed. With a spindle motor used for such mobile devices, a hydrodynamic bearing is generally used. A hydrodynamic bearing needs to have high reliability over a wide range of operating temperatures, but one area that is a particular problem is leakage of the lubricating fluid (lubricating oil) of the hydrodynamic bearing, and many different proposals have been aimed at solving this problem.

With the first prior art disclosed in Patent Document 1, a labyrinth seal is provided to a sleeve in order to prevent lubricant leakage. A hydrodynamic bearing is constituted such that the shaft is fixed and a separate hub is attached to the sleeve.

With the second prior art disclosed in Patent Document 2, the lubricating oil is sealed and leakage prevented by attaching a seal member to a shaft so as to sandwich a radial bearing between the shaft and a sleeve. A hydrodynamic bearing is constituted such that the shaft is fixed and a separate motor hub is attached to the sleeve.

Patent Document 1: Japanese Patent No. 3,519,457

Patent Document 2: Japanese Laid-Open Patent Application No. 2002-70849

### DISCLOSURE OF THE INVENTION

Problems which the Invention is Intended to Solve

With the first and second prior art disclosed in Patent Documents 1 and 2, assembly precision can be kept high in the direction of the rotational axis in the spindle motor assembly process. Nevertheless, since a sleeve that constitutes a radial bearing and a hub component that holds and fixes a magnetic disk are processed separately and the resulting components then combined, it is impossible to avoid a certain amount of off-centeredness (eccentricity) in the radial direction. Consequently, the sleeve vibrates during rotation, or the magnetic disk attachment plane is tilted with respect to the rotational axis. If the sleeve vibrates during rotation, the gap between the shaft and the sleeve fluctuates, so the lubricant that fills this gap may leak to the outside. With a hydrodynamic bearing of the type in which both ends of the shaft are fixed, both ends of the sleeve are open to the atmosphere. Consequently, if the hub component and other rotating bodies do not rotate precisely, the bearing portions will be subjected to greatly varying stress, the gap between the sleeve and shaft forming a radial dynamic bearing will fluctuate, and the lubricant filling this gap will be pushed out and leak to the outside.

It is an object of the present invention to provide a spindle motor of high reliability, with reduced leakage of lubricating fluid from a hydrodynamic bearing having a sleeve component, a hub component, and a shaft component (the bearing of the spindle motor).

Means Used to Solve the Above-Mentioned Problems

The spindle motor of the present invention has a hydrodynamic bearing which is a fluid bearing in which a narrow gap is formed between the outer peripheral surface of a fixed shaft member and the inner peripheral surface of a sleeve component into which the shaft member is inserted, and the narrow gap is filled with a lubricating fluid, wherein the shaft member has an annular collar that protrudes outward from and substantially perpendicular to the outer peripheral surface, and a thrust flange provided a specific distance away from the collar, and the sleeve component is constituted integrally with a hub component that fixes a magnetic disk, and is rotatably supported at a narrow gap by the shaft member between the collar and the thrust flange.

With this invention, since the annular collar is formed integrally with the shaft member, the shaft member has high precision in the axial direction. Also, since the sleeve component and the hub component that holds and fixes the magnetic disk, which are members that rotate, are configured integrally, precision of the sleeve component and hub component in the radial direction, and the tilt precision of the magnetic disk attachment plane with respect to the central axis of the sleeve component can be increased, and fluctuation of the magnetic disk plane during rotation can be kept extremely small.

Since the precision of the sleeve component and hub component in the radial direction, and the tilt precision of the magnetic disk attachment plane are higher, more stable rotation is obtained, and the gap between the sleeve component and the shaft member during rotation is stabilized, so there is no danger of the lubricating fluid leaking to the outside.

The spindle motor in another aspect of the present invention has a hydrodynamic bearing which is a fluid bearing in which a narrow gap is formed between the outer peripheral surface of a fixed shaft member and the inner peripheral surface of a sleeve component into which the shaft member is inserted, and the narrow gap is filled with a lubricating fluid, wherein the shaft member has an annular collar that protrudes outward from and substantially perpendicular to the outer peripheral surface, and a thrust flange provided a specific distance away from the collar, the sleeve component into which the shaft member is inserted, a hub component that fixes a magnetic disk, and a magnetic support component that substantially covers the outer peripheral surface or inner peripheral surface of a cylindrical magnet are constituted integrally, and [the sleeve component] is rotatably supported at a narrow gap by the shaft member between the collar and the thrust flange.

With this invention, since the annular collar is formed integrally with the shaft member, the shaft member has high precision in the axial direction. Also, since the sleeve component, which is a rotating member, is integral with the hub component that holds and fixes a magnetic disk, the precision of the sleeve component and hub component in the radial direction, and the tilt precision of the magnetic disk attachment plane with respect to the central axis of the sleeve component can be increased. Furthermore, since a back yoke for attaching a drive magnet is integral with the hub component, the precision of the rotational center of the back yoke with respect to the rotational center of the sleeve component is higher. As a result, there is less fluctuation in torque during rotation, and the rotation of the sleeve component is more stable, so there is almost no leakage of lubricating fluid to the outside.

The spindle motor in another aspect of the present invention has a hydrodynamic bearing which is a fluid bearing in which a narrow gap is formed between the outer peripheral surface of a fixed shaft member and the inner peripheral surface of a sleeve component into which the shaft member is inserted, and the narrow gap is filled with a lubricating fluid, wherein a first annular member is press-fitted on the lower end side of the shaft member, the sleeve component into which the shaft member is inserted and the hub component for fixing a magnetic disk are integrally constituted, and a second annular member is provided on the upper end side of the shaft member.

With this invention, in addition to the above-mentioned effects, a constitution in which annular members are attached to a rod-shaped shaft member is less expensive than a constitution in which annular members and a shaft member are integral, so the cost of the spindle motor can be lowered.

### EFFECT OF THE INVENTION

With the present invention, a sleeve component into which a shaft member is inserted and a hub component to which a magnetic disk is attached are constituted integrally, so there is little eccentricity between the sleeve component and the hub component. Accordingly, the rotation of the sleeve component is stabilized, there is no fluctuation in the gap between the shaft member and the sleeve component, and leakage of the lubricating fluid to the outside due to fluctuation in the gap can be prevented.

### BEST MODE FOR CARRYING OUT THE INVENTION

The spindle motors in preferred embodiments of the present invention will now be described through reference to FIGS. 1 to 3.

### Embodiment 1

The spindle motor in Embodiment 1 of the present invention will be described through reference to FIG. 1. FIG. 1 is a cross section of the left half of the spindle motor in Embodiment 1. The right half is not shown since it is symmetrical to the center line C.

In FIG. 1, a hydrodynamic bearing component used in the spindle motor of Embodiment 1 has a shaft member 1 and a rotating member 4 (hub component) equipped with a sleeve component 4a. The shaft member 1 is fixed at its lower end (in the drawing) to a base 9 and has a collar component 1a that protrudes outward and substantially perpendicularly from the outer peripheral surface near the fixed component. The shaft member 1 is inserted into the cylindrical sleeve component 4a with a narrow gap maintained therebetween. The sleeve component 4a is formed integrally with the rotating member 4. A plurality of magnetic disks 20 are attached to the rotating member 4. An annular thrust flange 2 that is across from the collar component 1a with the sleeve component 4a sandwiched therebetween is fixed by press fitting to the top part of the shaft member 1. An annular seal member 3 that acts as a seal and covers the thrust flange 2 from above is attached. The shaft member 1 is preferably made from a high-strength steel produced, for example, by adding 4 wt % or more manganese, 4 wt % or less nickel, and 12 to 18 wt % chromium to iron. When, for example, the sleeve component 4a is made from a relatively soft material such as aluminum, it is preferable to form a wear-resistant hard coating such as DLC on the inner peripheral surface of the sleeve component 4a, or to perform a surface treatment such as nickel plating, in order to prevent [excessive] wear when the sleeve component 4a is in contact with the shaft member 1. When the sleeve component 4a is made from aluminum or a copper alloy, it is preferable to form the shaft member 1 from austenite stainless steel, or a high-strength steel having a comparable coefficient of linear expansion. This is effective in terms of reducing variation in the gap between the sleeve component 4a and the shaft member 1, and preventing the leakage of lubricating fluid, even if the usage temperature changes.

A narrow gap 5 is formed between the sleeve component 4a and the shaft member 1. Also, narrow gaps 4c and 4b are formed between the sleeve component 4a and the thrust flange 2 and between the sleeve component 4a and the collar component 1a, respectively. The gaps 5, 4c, and 4b are filled with a lubricating fluid (lubricant) that serves as a working fluid. As a result, the sleeve component 4a is able to rotate around the fixed shaft member 1. The seal member 3 is used to prevent the lubricant from leaking from the upper end of the shaft member 1. A spiral or herringbone pattern radial dynamic pressure generating groove (not shown), which is well known in this field of art, is formed by rolling, which is a deformation processing known in the past, or by electrochemical machining, etching, or the like around the inner peripheral surface of the sleeve component 4a, thereby constituting a radial bearing. A thrust dynamic pressure generating groove (not shown) is also formed in a spiral or herringbone pattern in at least one of the opposing faces of the thrust flange 2 and the sleeve component 4a, and in at least one of the opposing faces of the collar component 1a and the sleeve component 4a, thereby constituting a thrust bearing.

A back yoke 6 made of a magnetic material is fixed to the rotating member 4, and a cylindrical magnet 7 is disposed on the inner peripheral surface of this yoke. A stator core 8 comprising a drive coil wound around the magnet 7 is disposed on the inner peripheral surface of the magnet 7 with a specific gap therebetween. The stator core 8 is fixed to the base 9 and constitutes a rotational drive component. The rotational drive component in FIG. 1 is such that the stator core 8 is disposed in the inner peripheral side of the magnet 7, but the magnet 7 may be disposed around the outer periphery of the back yoke 6, and the stator core 8 disposed on the outer peripheral side of the magnet 7 with a specific gap therebetween.

When electric power is supplied to the coil of the stator core 8, the magnet 7 receives a rotational drive force, and the rotating member 4, including the sleeve component 4a, rotates. The rotation of the sleeve component 4a results in the formation of a radial hydrodynamic bearing between the shaft member 1 and the sleeve component 4a. Also, a thrust hydrodynamic bearing is formed in the space 4b between the sleeve component 4a and the collar component 1a, and in the space 4c between the sleeve component 4a and the thrust flange 2, and the sleeve component 4a rotates without being in contact with the shaft member 1, the collar component 1a, or the thrust flange 2.

With Embodiment 1, since the rotating member 4 and the sleeve component 4a, which are rotating bodies, are constituted integrally and form a single component, the machining precision is higher, and eccentricity from the rotational axis C at the rotational center of the rotating member 4 can be minimized. Accordingly, there will be no vibration between the sleeve component 4a and the shaft component 1a during rotation, nor will the sleeve component 4a become tilted with respect to the shaft component 1a, and the rotating member 4 will rotate stably around the shaft member 1. This stable rotation allows the gap between the shaft member 1 and the sleeve component 4a to be kept constant during rotation, with no fluctuation. This means that the lubricating fluid filling the gap between the shaft member 1 and the sleeve component 4a of the radial hydrodynamic bearing will not be pushed out of this gap and leak to the outside.

### Embodiment 2

The spindle motor of Embodiment 2 of the present invention will be described through reference to FIG. 2. FIG. 2 is a cross section of the left half of the spindle motor in Embodiment 2. The right half is not shown since it is symmetrical to the center line C.

In FIG. 2, the constitution of the shaft member 1, the thrust flange 2, the seal member 3, the stator core 8, and the base 9 is the same as that in Embodiment 1 shown in FIG. 1, and these components operate in the same manner and will therefore not be described again.

With Embodiment 2, only the constitution of a rotating member 14 (hub component) is different from that of the rotating member 4 in FIG. 1. The rotating member 14 has an integrally constituted sleeve component 14a and back yoke 14b. The sleeve component 14a is constituted the same as the sleeve component 4a in FIG. 1, and operates the same.

The back yoke 6 in Embodiment 1 shown in FIG. 1 is attached to the rotating member 4 as a separate component, so depending on how it is attached, there may be deviation (eccentricity) between the center axis of the rotating member 4 and the center axis of the back yoke 6. Accordingly, the attachment step entails high-precision work, which means that attachment takes longer and is more expensive.

The hydrodynamic bearing in Embodiment 2 is characterized in that the back yoke 14b is formed integrally with the rotating member 14, so the machining precision of the back yoke 14b can be kept high. Since the back yoke 14b must be made of a magnetic material, the rotating member 14 that is constituted integrally with the back yoke 14b is made from a magnetic material such as JIS SUS 420. This limits the materials that can be used for the rotating member 14, but also reduces assembly cost, so the total cost is lower. The material of the shaft member 1 may also be SUS 420 or the like, but is preferably a high-strength steel. With the spindle motor in Embodiment 2, since the sleeve component 14a, the rotating member 14, and the back yoke 14b are constituted integrally, deviation (eccentricity) between these can be kept extremely small. This means that the sleeve component 14a will rotate extremely stably around the shaft member 1. This stable rotation allows the gap between the sleeve component 14a and the shaft member 1 to be held constant, so there is almost no leakage of lubricating fluid to the outside. Furthermore, the magnet 7 may be disposed on the outer peripheral side of the back yoke 14b, and the stator core 8 disposed on the outer peripheral side of the magnet 7.

### Embodiment 3

The spindle motor in Embodiment 3 of the present invention will be described through reference to FIG. 3. FIG. 3 is a cross section of the left half of the spindle motor in Embodiment 3. The right half is not shown since it is symmetrical to the center line C.

In FIG. 3, the constitution of the thrust flange 2, the seal member 3, the rotating member 4 (hub component) and its sleeve component 4a, the back yoke 6, the magnet 7, the stator core 8, and the base 9 is the same as that in Embodiment 1 shown in FIG. 1, and these components operate in the same manner and will therefore not be described again.

With Embodiment 3, the constitution of a shaft member 10 and a thrust flange 11 is different from the constitution in Embodiment 1. The rod-shaped shaft 10 is fixed at its lower end (in the drawing) to the base 9. The thrust flange 11 (first annular member) is fixed to the shaft 10 near the base 9. The sleeve component 4a is provided between the thrust flange 11 and the thrust flange 2 (second annular member) fixed to the upper end of the shaft 10. A thrust dynamic pressure generation groove (not shown) is provided to at least one of the opposing faces of the sleeve component 4a and the thrust flange 11.

With Embodiment 3, since the annular thrust flange 11 is attached to the rod-shaped shaft 10, the structure of the shaft 10 is simpler than that of the shaft member 1 in Embodiment 1, which affords a cost reduction for the shaft member. Again with the spindle motor in Embodiment 3, just as with that in Embodiment 1, the sleeve component 4a is constituted integrally with the rotating member 4, so the sleeve component 4a rotates stably around the shaft member 1. Therefore, the gap between the sleeve component 4a and the shaft member 1 during rotation is held stable, so there is no danger that the lubricating fluid will leak to the outside.

Several embodiments were selected and described in order to describe the present invention, but a person skilled in the art will be capable of performing various modifications and improvements without deviating from the scope of the invention as defined in the appended claims. Also, the embodiments of the present invention given above are given for the purpose of illustration, and not for the purpose of limiting the invention as defined in the claims and equivalents thereof.

### INDUSTRIAL APPLICABILITY

The present invention can be utilized in a spindle motor that requires a high-precision hydrodynamic bearing.

### BRIEF DESCRIPTION OF THE DRAWINGS

FIG. 1 is a cross section of the left half of the spindle motor in Embodiment 1;

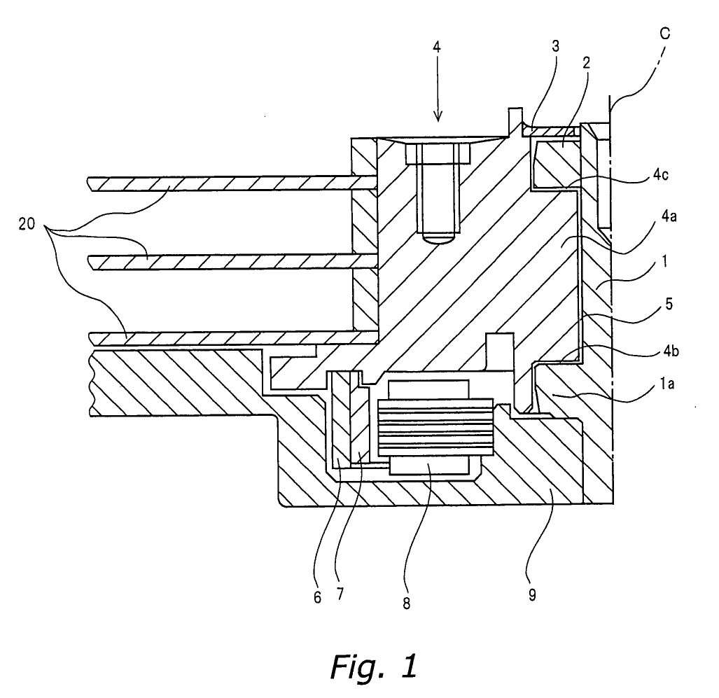

FIG. 2 is a cross section of the left half of the spindle motor in Embodiment 2; and

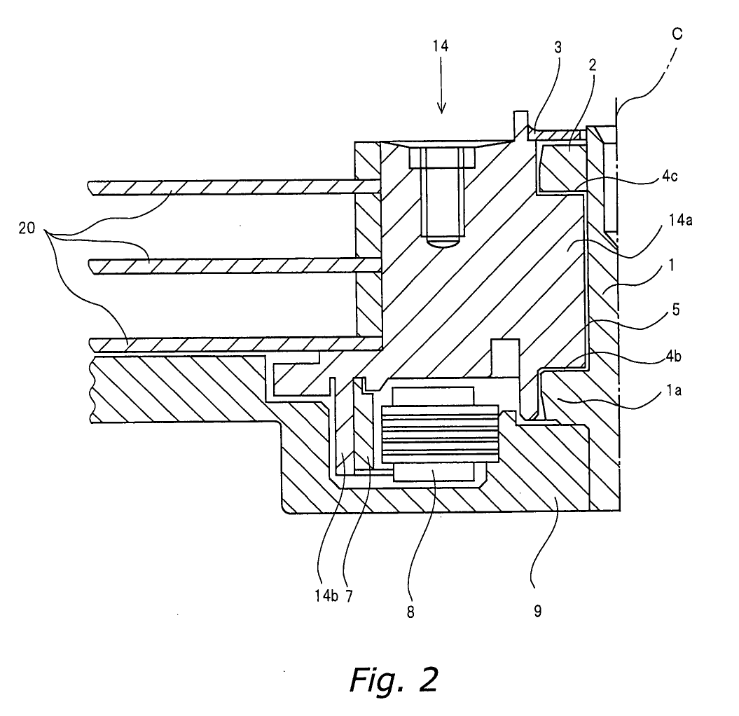

FIG. 3 is a cross section of the left half of the spindle motor in Embodiment 3.

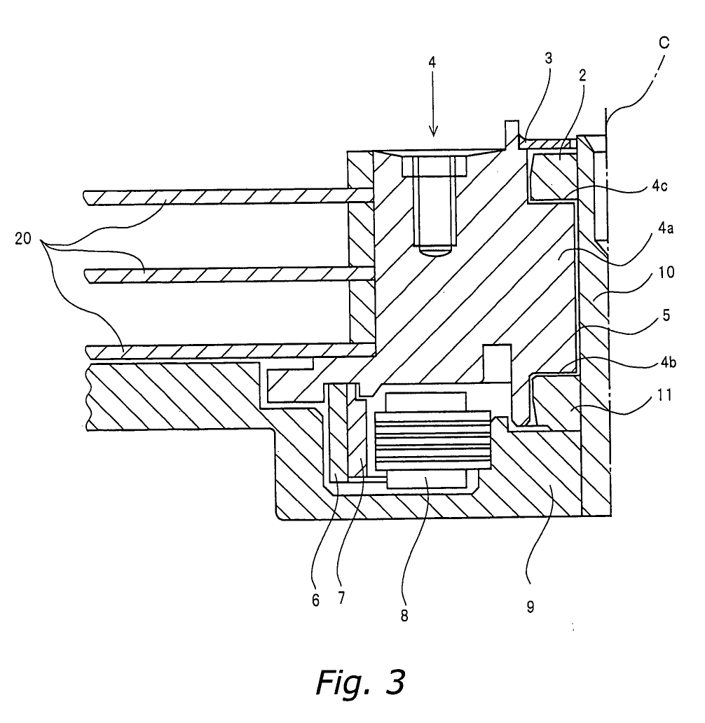

### KEY

1, 10 shaft member
2, 11 thrust flange
3 seal member
4, 14 rotating member
4a, 14a sleeve component
5 gap
6 back yoke
7 magnet
8 stator core
9 base

1. A spindle motor having a hydrodynamic bearing which is a fluid bearing in which a narrow gap is formed between the outer peripheral surface of a fixed shaft member and the inner peripheral surface of a sleeve component into which the shaft member is inserted, and the narrow gap is filled with a lubricating fluid,
wherein the shaft member has an annular collar that protrudes outward from and substantially perpendicular to the outer peripheral surface, and a thrust flange provided a specific distance away from the collar, and
the sleeve component is constituted integrally with a hub component that fixes a magnetic disk, and is rotatably supported at a narrow gap by the shaft member between the collar and the thrust flange.

2. The spindle motor according to claim 1, equipped with a hydrodynamic bearing, having a radial dynamic pressure generating groove in the opposing face of the shaft member and/or that of the sleeve component, having a first thrust dynamic pressure generating groove in the opposing face of the collar and/or that of the sleeve component, and having a second thrust dynamic pressure generating groove in the opposing face of the thrust flange and/or that of the sleeve component.

3. The spindle motor according to claim 1, equipped with a hydrodynamic bearing wherein the inner peripheral surface of the sleeve component has been subjected to a surface treatment.

4. The spindle motor according to claim 1, equipped with a hydrodynamic bearing wherein the shaft member is made of high-strength steel producing by adding 4 wt % or more manganese, 4 wt % or less nickel, and 12 to 18 wt % chromium to iron.

5. A spindle motor having a hydrodynamic bearing which is a fluid bearing in which a narrow gap is formed between the outer peripheral surface of a fixed shaft member and the inner peripheral surface of a sleeve component into which the shaft member is inserted, and the narrow gap is filled with a lubricating fluid,
wherein the shaft member has an annular collar that protrudes outward from and substantially perpendicular to the outer peripheral surface, and a thrust flange provided a specific distance away from the collar,
the sleeve component into which the shaft member is inserted, a hub component that fixes a magnetic disk, and a magnetic support component for supporting the outer peripheral surface or inner peripheral surface of a cylindrical magnet that imparts a rotational force to the hub component are constituted integrally, and
the sleeve component is rotatably supported at a narrow gap by the shaft member between the collar and the thrust flange.

6. The spindle motor according to claim 5, having a hydrodynamic bearing in which the sleeve component and the hub component are made from a magnetic material.

7. The spindle motor according to claim 5, having a hydrodynamic bearing wherein the inner peripheral surface of the sleeve component has been subjected to a surface treatment.

8. The spindle motor according to claim 5, having a hydrodynamic bearing wherein the shaft member is made of high-strength steel producing by adding 4 wt % or more manganese, 4 wt % or less nickel, and 12 to 18 wt % chromium to iron.

9. A spindle motor having a hydrodynamic bearing which is a fluid bearing in which a narrow gap is formed between the outer peripheral surface of a fixed shaft member and the inner peripheral surface of a sleeve component into which the shaft member is inserted, and the narrow gap is filled with a lubricating fluid,
wherein a first annular member is press-fitted on the lower end side of the shaft member, the sleeve component into which the shaft member is inserted and the hub component for fixing a magnetic disk are integrally constituted, and a second annular member is provided on the upper end side of the shaft member.
